(19) United States
(12) Patent Application Publication
(10) Pub. No.: US 2009/0216437 A1
(43) Pub. Date: Aug. 27, 2009

(54) Method for operating a navigation device

(76) Inventor: Jurgen Meier, Waldbrunn (DE)

Correspondence Address: QUARLES & BRADY LLP, 411 E. WISCONSIN AVENUE, SUITE 2040, MILWAUKEE, WI, 53202-4497, US

(21) Appl. No.: 12/370,703

(22) Filed: Feb. 13, 2009

(30) Foreign Application Priority Data
Feb. 25, 2008 (DE) 10 2008 010 880.4
Apr. 28, 2008 (DE) 10 2008 021 235.0

(51) Int. Cl. G01C 21/36

(52) U.S. Cl. 701/209

(57) ABSTRACT

A method for operating a navigation device, including an input unit, into which location information, particularly starting points and/or destination points, may be entered, a road network database, a route calculation unit for calculating a planned route, taking into account location information and the road network database, wherein the route leads from the starting point to the destination point, a position determining unit, in which a location to be displayed and/or a direction of motion to be displayed are calculated, a display unit, on which the location to be displayed and a graphical map representation of the area surrounding the location to be displayed can be shown, wherein the orientation of the map representation can be changed according to the direction of motion to be displayed, wherein the method includes
a) a change in the direction of motion to be displayed is detected in the position determining unit,
b) a lag time is interposed,
c) the orientation of the map representation is changed according to the change detected in the direction of motion to be displayed.

### CROSS-REFERENCE TO RELATED APPLICATION

This application claims the priority benefit of German Patent Application No. 10 2008 010 880.4 filed on Feb. 25, 2008, and German Patent Application No. 10 2008 021 235.0 filed on Apr. 28, 2008, the contents of which are hereby incorporated by reference as if fully set forth herein in their entirety.

### STATEMENT CONCERNING FEDERALLY SPONSORED RESEARCH OR DEVELOPMENT

Not applicable.

### FIELD OF THE INVENTION

The invention relates to a method for operating a navigation device including an input unit, into which location information, particularly starting points and/or destination points, may be entered, a road network database, a route calculation unit for calculating a planned route, taking into account location information and the road network database, wherein the route leads from the starting point to the destination point, a position determining unit, in which a location to be displayed and/or a direction of motion to be displayed are calculated, and a display unit, on which the location to be displayed and a graphical map representation of the area surrounding the location to be displayed can be shown, wherein the orientation of the map representation can be changed according to the direction of motion to be displayed.

### BACKGROUND OF THE INVENTION

Generic navigation devices are used in motor vehicles, for example, where they guide the driver from a starting point to a destination point along a pre-calculated route, but their applications are by no means limited to this. In this context, the driver can transfer the starting and destination points or other information to the navigation device via an input device. The route is calculated on the basis of the data in a road network database.

The driver is then shown a graphical map representation of the area around his current location on a display unit, for example a touch-screen, to assist him in performing the necessary maneuvers as he follows the route. The location that is needed for the display on a display unit is calculated in a position determining unit; for this, the data from a satellite receiver is evaluated, for example.

In older navigation devices, the map representation to be displayed was always orientated on the North. However, this north-oriented alignment of the map representation was disadvantageous to the driver following the route, since obviously the vehicle was not always traveling in the northward direction and the driver had to rotate the map representation appropriately in his imagination. As a result, this north-orientated map representation was not widely accepted by users.

Accordingly, more sophisticated navigation devices were proposed in which the orientation of the map representation was displayed on the basis of the detected direction of motion. The direction of motion at any given time may be detected by various methods. Either the current GPS satellite signals are evaluated for this purpose or the direction of travel is adapted in the digital map (map-matched position). In the map-matched position, the direction of travel corresponds to the direction of the street element in which the current location is positioned. In a refinement, predicted locations and directions of motion were also used since the current location can only be determined by evaluating satellite signals with a certain clock frequency.

When the map representation is displayed, its orientation is changed according to the direction of motion that is to be displayed, which means for example that the top border of the map representation to be displayed always points in the current direction of motion. In this way, the driver is helped to understand the displayed map representation intuitively, since the user is regularly looking in exactly the same direction as the current direction of motion. In this case, the user no longer needs to make a mental adjustment, because the map representation is aligned with the direction of motion, thus enabling him to understand the map intuitively, since the map representation corresponds to his visual perception. Particularly in systems that enable a 2.5-D or 3-D representation, this alignment with the direction of travel is essential.

However, the map representation aligned with the direction of travel poses problems when the direction of motion that serves as the basis for the representation is not determined correctly. A map representation that is aligned with the wrong direction of motion is extremely confusing for the driver.

### SUMMARY OF THE INVENTION

Starting from this related art, the object of the present invention is therefore to suggest a new method for operating a navigation device with which the intuitive comprehensibility of the map representation aligned with the direction of motion is improved.

This object is achieved one embodiment of the invention in a method in which a change in the direction of motion to be displayed is detected in the position determining unit, a lag time is interposed, and the orientation of the map representation is changed according to the change detected in the direction of motion to be displayed.

The basis for the method according to one embodiment of the invention is the realization that the incorrect representation of the map's orientation in the display, which is confusing for the driver, is caused by the fact that in some situations the direction of motion to be displayed is not determined correctly. In these cases, in the known navigation devices the map representation is rotated to match the incorrect direction of motion and must then be rotated back as soon as the direction of motion is determined correctly. This adjustment back and forth of the map representation is extremely disorientating for the driver. In order to avoid this effect, according to one embodiment of the invention it is therefore suggested to initially interpose a lag time after a change in the direction of motion to be displayed has been detected, before the map representation is changed to reflect the detected change in the direction of motion to be displayed. Advantageously, this avoids unnecessary rotations of the map that are caused by the incorrectly detected directions of motion. As a result of allowing this lag time, it is possible to filter out the errors in detecting the direction of motion to be displayed, so that incorrect directions of motion are never or very seldom used as the basis for changing the map orientation.

This method offers particularly important advantages when the current location and direction of motion to be displayed are forecast in a forecasting unit, for example because detecting the current location by evaluating sensor signals, particularly satellite signals, is only possible with clocking or a time delay. The reason is that any forecast of a location or direction of motion is inherently inaccurate. The forecast of a location or direction of motion uses the most recent location derived by receiving and evaluating position signals and forecasts a new location on the basis of this current location as detected by sensor signals. Information such as the speed of the vehicle, the course of the stretches of road the vehicle is traveling on, or the course of the planned route may be included in the calculation for this. In particular, the forecast of the location or direction of travel may serve to compensate for the delay in GPS position determination. Allowing a lag time is a simple and very effective way to avoid using the inherently unreliable determination of the location or direction of motion as the basis for rotating the map representation.

In general, this lag time by which the rotation of the map representation is delayed may be of any length. According to a first method variant, it is envisaged that in each case the lag time is of predetermined duration and begins from the point in time when the change in the direction of motion to be displayed is detected. In this context, the lag time may for example lie within a time horizon from 0.5 seconds to 5 seconds. This lag time of a few seconds does not inconvenience the driver, and at the same time it enables almost all errors to be filtered out while the current direction of motion is determined.

According to an alternative method variant, a variable lag time is envisaged. This variable lag time is determined in each case by the length of time it takes to determine the direction of motion by re-evaluating positions signals with the time signal receiving unit. In other words, this means that in this variant each rotation of the map representation to be displayed is delayed until the direction of motion has been determined by evaluation of the sensor signals. This completely eliminates errors based on forecasts of the direction of motion.

In order to keep the driver informed during the lag time of the currently determined direction of motion, which may be based on a forecast, for example, the orientation of the symbol representing the location, for example an arrow, may be changed according to the forecast direction of motion. For example, if forecasting of the direction of motion has determined that the vehicle has turned through 45° since the last position determination, the arrow symbol representing the current location is also rotated through 45° in the map to be displayed. The entire map representation is not rotated through 45° until this result is confirmed by evaluating position signals, for example GPS satellite signals. Of course the symbol representing the location is rotated back after the map representation has been re-orientated. In this way, the orientation of the map representation and the orientation of the symbol representing the location are synchronized again.

Of course, the orientation of the displayed map representation may be changed one step at a time, so that the change in the map orientation may be displayed incrementally in accordance with the image refresh frequency of the display unit used. Since the preferred method of the invention allows a certain lag time when the orientation of the map to be displayed is changed, the display of the change in the map's orientation may thus be improved by effecting the change in the orientation of the displayed map representation in multiple steps or even quasi-continuously. Thus, the map representation is no longer rotated in a single step, but in multiple steps or quasi-continuously, thereby presenting a correspondingly smooth rotating movement of the map representation on the display of the display unit.

Various aspects and other objectives of the invention are shown schematically in the drawing and will be explained for exemplary purposes in the following.

### BRIEF DESCRIPTION OF THE DRAWINGS

FIG. 1 shows a comparison of a conventional map representation and a map representation according to the invention when displaying a first maneuver in three steps; and

FIG. 2 shows a comparison of a conventional map representation and the map representation according to the invention when performing a second maneuver in three steps.

### DETAILED DESCRIPTION OF THE EXAMPLE EMBODIMENTS

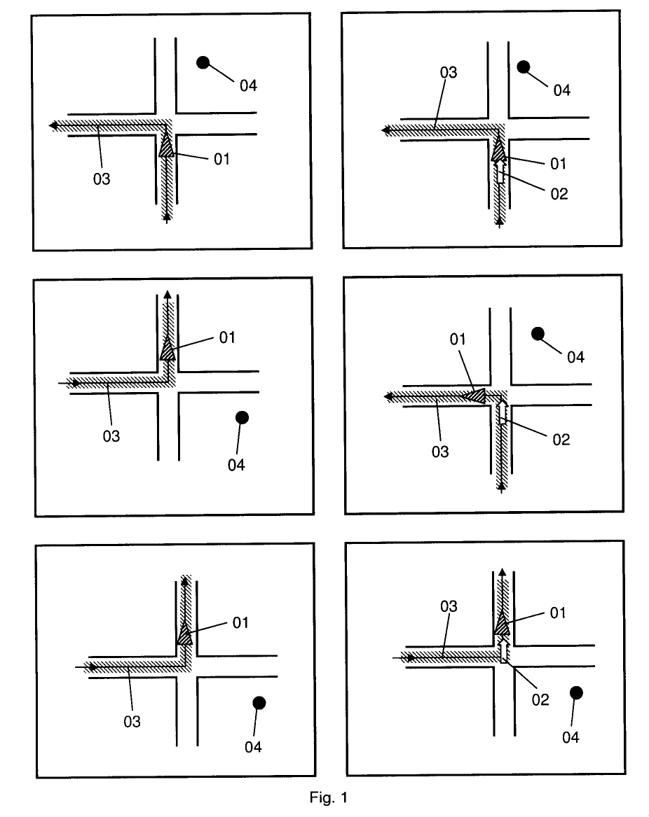

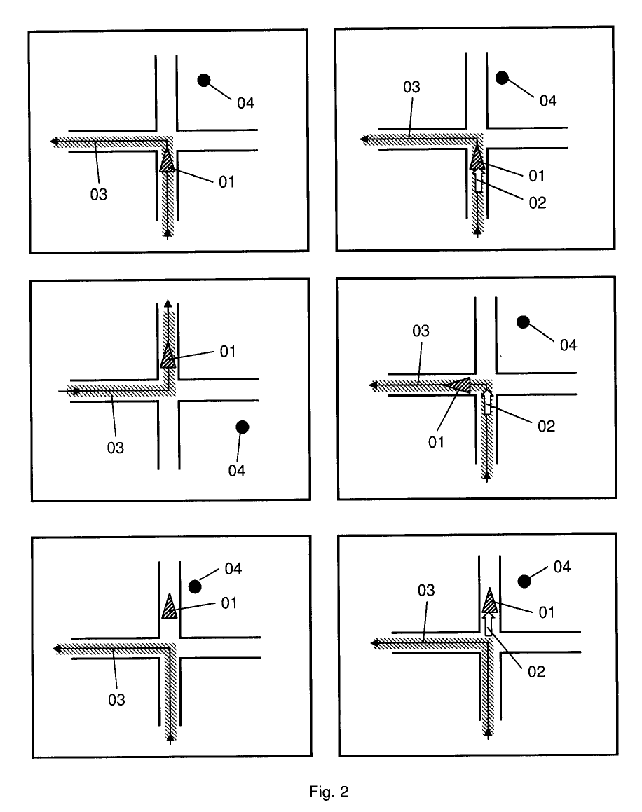

In both FIG. 1 and FIG. 2, the conventional method for displaying a maneuver appears on the left, and the method incorporating the invention for displaying a maneuver is shown on the right for comparison purposes. The first arrow symbol 01 symbolizes both a forecast location and a forecast direction of travel. In contrast, the arrow symbol 02 symbolizes the current location as detected by evaluating GPS satellite signals, which location may only be detected with a time delay because the satellite signal is evaluated according to a clock. Additionally, the planned route is shown as trace 03 in both cases. In order to show the orientation of the map representation on the display unit, an orientation point 04 is indicated in both FIG. 1 and FIG. 2.

The maneuver represented by both the conventional method and the inventive method as shown in FIG. 1 is a left turn, in which the planned trace 03 is followed. In the conventional display, the vehicle in the top panel is still approaching the crossroads, and the displayed map representation matches the forecast direction of travel. As is shown in the middle panel, as soon as the forecast location and the forecast direction of travel are beyond the crossroads, the map representation is rotated through 90°, so that the orientation of the map representation again matches the forecast direction of travel. If the vehicle then follows the planned route, the map remains in this orientation.

The three map representations on the right correspond to the map representation according to the method incorporating the invention. As before, the situation before the vehicle reaches the crossroads is illustrated in the top panel, while in this case the orientation of the map representation reflects the direction of travel corresponding to the most recent evaluation of GPS position signals.

If the position forecast predicts that the vehicle will turn the corner, as is shown by the arrow symbol 01 in the middle map representation, the map representation is initially not rotated through 90°, as happens with the conventional display method, but a lag time is interposed instead. As illustrated in the bottom panel, the map representation is not rotated clockwise through 90° until it is has been reliably confirmed by evaluation of the GPS position signals that the vehicle really has turned left, so that the map representation again matches the detected direction of motion.

FIG. 2 illustrates the difference between the map representation incorporating the invention and the conventional map representation when the vehicle makes an unplanned deviation from the route. In this figure also the planned route entails making a left turn. In the conventional map representation, the map representation would first be rotated clockwise through 90° on the basis of the location forecast, as shown in the middle panel. If evaluation of the GPS satellite signals subsequently reveals that the vehicle did not turn left after all, but continued straight through the crossroads, thereby deviating from the route, the map representation must be rotated again through 90° counterclockwise, to its former orientation.

In the map representation incorporating the invention, as is shown schematically on the right of FIG. 2, this undesirable rotation of the map representation, which is confusing for the driver, is avoided. As before, the location forecast indicates that the vehicle will turn left, but in this case the map representation is not rotated immediately (middle panel), instead the system waits to receive the next evaluation of GPS satellite signals. If this then indicates that the driver has deviated from the route and has not turned left but driven straight on over the crossroads, the map representation is not rotated, since the direction of travel still matches the map orientation.

While there has been shown and described what are at present considered the preferred embodiment of the invention, it will be obvious to those skilled in the art that various changes and modifications can be made therein without departing from the scope of the invention defined by the appended claims. Therefore, various alternatives and embodiments are contemplated as being within the scope of the following claims particularly pointing out and distinctly claiming the subject matter regarded as the invention.

1. A method for operating a navigation device, including
an input unit, into which operator commands and/or location information, particularly starting points and/or destination points, may be entered,
a road network database,
a route calculation unit for calculating a planned route, taking into account location information and the road network database, wherein the route leads from the starting point to the destination point,
a position determining unit, in which a location to be displayed and/or a direction of motion to be displayed are calculated,
a display unit, on which the location to be displayed and a graphical map representation of the area surrounding the location to be displayed can be shown, wherein the orientation of the map representation can be changed according to the direction of motion to be displayed,
said method comprising the steps of
a) a change in the direction of motion to be displayed is detected in the position determining unit,
b) a lag time is interposed,
c) the orientation of the map representation is changed according to the change detected in the direction of motion to be displayed.

2. The method according to claim 1, in which the position determining unit includes a signal receiving unit and a forecasting unit, wherein the location is determined with the signal receiving unit by receiving and evaluating position signals, particularly satellite signals, and wherein a probable location to be displayed is forecast with the forecasting unit extrapolating at least from the last location determined by position determination.

3. The method according to claim 2, in which a probable direction of motion to be displayed is forecast by the forecasting unit.

4. The method according to claim 1, in which the probable location forecast by the forecasting unit is displayed in the map representation shown on the display unit, wherein the change of orientation of the displayed map representation is delayed by a lag time.

5. The method according to claim 1, in which the lag time corresponds to a fixed, predetermined time interval, in particular that the lag time lasts 0.5 seconds to 5 seconds starting from the time when the change in the direction of motion to be displayed is detected.

6. The method according to claim 1, in which the change in orientation of the displayed map representation is delayed by a variable lag time until the direction of motion is determined by a new evaluation of position signals in the signal receiving unit.

7. The method according to claim 1, in which the direction of motion forecast by the forecasting unit is displayed in the map representation on the display unit in that the orientation of the symbol representing the location is changed in accordance with the direction of motion that is forecast by the forecasting unit.

8. The method according to claim 1, in which the orientation of the displayed map representation is changed in multiple increments or continuously according to the detected change in the direction of motion.

9. A method for operating a navigation device, said navigation device including an input unit, into which location information, particularly starting points and/or destination points, may be entered, a road network database, a route calculation unit for calculating a planned route, taking into account location information and the road network database, wherein the route leads from the starting point to the destination point, a position determining unit, in which a location to be displayed and/or a direction of motion to be displayed are determined, a display unit, on which the location to be displayed and a graphical map representation of the area surrounding the location to be displayed can be shown, wherein the orientation of the map representation can be changed according to the direction of motion to be displayed, said method comprising the steps of
a) detecting a change in the direction of motion to be displayed using the position determining unit;
b) delaying the display of the orientation of the map representation according to the detected change in direction of motion for a predetermined lag time; and
c) changing the orientation of the map representation according to the change detected in the direction of motion to be displayed.
